(19) United States
(12) Patent Application Publication
(10) Pub. No.: US 2014/0298021 A1
(43) Pub. Date: Oct. 2, 2014

(54) METHOD AND SYSTEM FOR STORING INFORMATION BY USING TCP COMMUNICATION

(71) Applicant: Korea University Research and Business Foundation, Seoul (KR)

(72) Inventors: Shin-il Kwon, Seoul (KR); Sungdeok Cha, Seoul (KR); Se-Hun Jung, Seoul (KR); Young-Gab Kim, Gyeonggi-do (KR)

(21) Appl. No.: 14/351,035

(22) PCT Filed: Oct. 10, 2012
(86) PCT No.: PCT/KR2012/008194

§ 371 Date: Apr. 10, 2014

(30) Foreign Application Priority Data
Oct. 10, 2011 (KR) 10-2011-0103135

(51) Int. Cl. H04L 29/06

(52) U.S. Cl. CPC H04L 63/0428
USPC 713/168

(57) ABSTRACT

The present invention relates to a method and system for storing information using TCP communication, and the method includes a communication connection request operation of transmitting, by a client, to a server a first TCP packet containing a header with a SYN field set to be active and an SEQ field in which a random number generated by the client is included, to request a TCP communication connection with the server, an encryption operation of encrypting, by the server, at least one piece of information to be stored in the first TCP packet, a communication connection confirmation operation of transmitting, by the server, to the client a second TCP packet containing a header with a SYN field set to be active, a SEQ field in which the encrypted information is stored, and an ACK field in which a value obtained by adding 1 to the random number included in the SEQ field of the first TCP packet is stored, a response operation of transmitting, by the client, to the server a third TCP packet containing a header with an ACK field set to be active, a SEQ field in which a value obtained by adding 1 to the random number stored in the SEQ field in the header of the first TCP packet is stored, and the ACK field in which a value obtained by adding 1 to the encrypted information is included, a decryption operation of decrypting, by the server, the ACK field in the header of the third TCP packet to acquire the encrypted information, and a determination operation of comparing, by the server, information stored in an IP packet residing at a lower level than the second TCP packet to a value obtained by decrypting a result of subtracting 1 from the ACK field in the header of the third TCP packet, and if they are identical, determining that the information is stored in the SEQ field of the second TCP packet and the ACK field of the third TCP packet.

### TECHNICAL FIELD

The present disclosure relates to a method and system for storing information using Transmission Control Protocol (TCP) communication, and more particularly, to a method and system for storing information using TCP communication that may allow a server to store specific information in a network packet at the same time with performing a connection process of TCP communication between the server and a client.

### BACKGROUND ART

Transmission Control Protocol (TCP) communication between a server and a client requests a communication connection after learning an Internet Protocol (IP) address and a port of the other party, and in this instance, if the server receiving a request for communication connection from the client does not respond to the requested communication connection, a communication connection request is continuously made. Later, when a communication connection is established, the server and the client perform a bi-directional communication until the communication is disconnected. This TCP communication includes, particularly, a mechanism of detecting whether data to be transmitted was transmitted correctly, and thus, when data to be transmitted is not received, may perform re-transmission of the data, which guarantees reliability of data transmission.

Hereinafter, a detailed description of a basic connection process of TCP communication is provided with reference to FIG. 1.

FIG. 1 is a flowchart illustrating a basic connection process of TCP communication between a server and a client.

As shown in FIG. 1, for communication between a client 10 and a server 20, TCP communication first transmits, by the client 10, a first TCP packet containing a header with a flag of a SYN field set to 1 to the server 20 (S11). In this instance, the flag of the SYN field being 1 is used in a sense that the client 10 requests a TCP communication connection to the server 20.

Then, in response to the received first TCP packet, the server 20 makes preparation for a TCP connection with the client 10 (S12).

Afterward, the server 20 completes the preparation process for a TCP connection with the client 10, and in response to the received first TCP packet, transmits a second TCP packet containing a header with a flag of an ACK field set to 1 and a flag of a SYN field set to 1 to the client 10 (S13).

In this instance, the flag of the SYN field in the header of the second TCP packet transmitted from the server 20 being set to 1 is transmitted in a sense that the server 20 also wishes to establish a communication connection with the client 10.

Then, the client 10 receiving the second TCP packet with the flag of the SYN field and the flag of the ACK field each set to 1 from the server 20 makes preparation for a TCP connection with the server 20 in response thereto (S14).

Afterward, the client 10 finishes preparing for a TCP connection with the server 20, and in response to the received second TCP packet, transmits a third TCP packet containing a header with a flag of an ACK field set to 1 to the server 20 (S15), as a consequence, a TCP connection between the server 20 and the client 10 is completed (S16).

In the TCP communication connection between the server 20 and the client 10, the server 20 stores various pieces of information of the client accessing an internal memory space, such as an IP address, an access time, a SEQ number, a window size, and the like, through the packet transmitted therebetween. Accordingly, to store a large amount of various information such as an IP address, an access time, a SEQ number, and a window size of the client 10, and the like, the server 20 has to do a tiresome job of allocating a separate memory space, as a result, there is a problem with resource consumption and a heavy load on the server 20 in an abnormal situation such as a denial-of-service (DoS) attack or a distributed denial-of-service (DDoS) attack.

As described in the foregoing, related arts of a TCP communication connection between a server and a client are as follows.

Related art 1, Korean Patent Laid-open Publication No. 2011-0018528 (Feb. 24, 2011), relates to an apparatus and method for defending TCP SYN flooding attacks on a network. The related art 1 transmits a SYN packet with a timestamp option to a client when receiving, from the client, a SYN packet for connection setting between the client and a server, and when receiving an ACK packet with a timestamp option from the client, establishes a connection between the client and the server, thereby efficiently defending against a malicious TCP SYN flooding attack on a network.

Also, Related art 2, Korean Patent Laid-open Publication No. 2011-0070750 (Jun. 24, 2011), relates to an apparatus and method for managing a safe TCP connection. The related art 2 effectively blocks a DoS attack on a TCP connection by generating an authentication key based on a SYN packet received for a TCP connection and transmitting the authentication key to a user terminal, determining whether a TCP connection is valid based on an analysis result of a response signal from the user terminal to the transmitted authentication key along with the SYN packet, and controlling transmission and reception of a data packet from the user terminal to a communication server based on a result of the determination as to whether the TCP connection is valid.

### DISCLOSURE

### Technical Problem

To solve the problems of the related arts, the present disclosure aims to provide a method and system for storing information using transmission control protocol (TCP) communication that may allow, in a TCP communication connection between a server and a client, the server to store specific information to be stored in a header of a TCP packet transmitted and received during TCP communication, thereby storing the specific information without using a separate storage space.

### Technical Solution

To achieve the above object, a method for storing information using transmission control protocol (TCP) communication according to an exemplary embodiment includes a communication connection request operation of transmitting, by a client, to a server a first TCP packet containing a header with a SYN field set to be active and an SEQ field in which a random number generated by the client is included, to request a TCP communication connection with the server, an encryption operation of encrypting, by the server, at least one piece of information to be stored in the first TCP packet, a communication connection confirmation operation of transmitting, by the server, to the client a second TCP packet containing a header with a SYN field set to be active, a SEQ field in which the encrypted information is stored, and an ACK field in which a value obtained by adding 1 to the random number included in the SEQ field of the first TCP packet is stored, a response operation of transmitting, by the client, to the server a third TCP packet containing a header with an ACK field set to be active, a SEQ field in which a value obtained by adding 1 to the random number stored in the SEQ field in the header of the first TCP packet is stored, and the ACK field in which a value obtained by adding 1 to the encrypted information is included, a decryption operation of decrypting, by the server, the ACK field in the header of the third TCP packet to acquire the encrypted information, and a determination operation of comparing, by the server, information stored in an IP packet residing at a lower level than the second TCP packet to a value obtained by decrypting a result of subtracting 1 from the ACK field in the header of the third TCP packet, and if they are identical, determining that the information is stored in the SEQ field of the second TCP packet and the ACK field of the third TCP packet.

Particularly, the method for storing information using TCP communication may include the encryption operation of encrypting information including a Time To Live (TTL) value and an Internet Protocol (IP) value contained in an IP header paired with a TCP header used for TCP communication.

Particularly, the method for storing information using TCP communication may include the encryption operation of hashing, by the server, the TTL value and the IP value, and encrypting the hash value using unique information of the server.

Particularly, the method for storing information using TCP communication may include the encryption operation of changing, by the server, the unique information every preset time.

To achieve the above object, a system for storing information using TCP communication is characterized by including a server to receive, from a client, a first TCP packet containing a header with a SYN field set to be active and an SEQ field in which a random number generated by the client is included, to encrypt at least one piece of information to be stored in the TCP packet, to transmit, to the client, a second TCP packet containing a header with a SYN field and an ACK field set to be active, a SEQ field in which the encrypted information is stored, and the ACK field in which a value obtained by adding 1 to the random number included in the SEQ field of the first TCP packet is stored, to receive, from the client, a third TCP packet containing a header with an ACK field set to be active, a SEQ field in which a value obtained by adding 1 to the random number stored in the SEQ field in the header of the first TCP packet is stored, and the ACK field in which a value obtained by adding 1 to the encrypted information is stored, to decrypt the ACK field in the header of the third TCP packet to acquire the encrypted information, to compare information stored in an IP packet residing at a lower level than the second TCP packet to a value obtained by decrypting a result of subtracting 1 from the ACK field in the header of the third TCP packet, and if they are identical, to determine that the information is stored in the SEQ field of the second TCP packet and the ACK field of the third TCP packet.

Particularly, the system for storing information using TCP communication may include the server to encrypt information including a TTL value and an IP value contained in an IP header paired with a TCP header used for TCP communication.

Particularly, the system for storing information using TCP communication may include the server to hash the TTL value and the IP value, and encrypt the hash value using unique information of the server.

Particularly, the system for storing information using TCP communication may include the server to change the unique information every preset time.

### ADVANTAGEOUS EFFECTS

The method and system for storing information using Transmission Control Protocol (TCP) communication according to the present disclosure allows, in a TCP communication connection between a server and a client, the server to store specific information to be stored in a SEQ field and an ACK field in a header of a TCP packet transmitted and received between the server and the client, thereby providing an effect of easily storing the specific information without using a separate storage space.

Also, the method and system for storing information using TCP communication according to the present disclosure allows a server to store specific information to be stored in a SEQ field and an ACK field in a header of a TCP packet transmitted to and received from a client for a TCP communication connection rather than a separate storage space, thereby providing an effect of reducing a load on the server.

Furthermore, the method and system for storing information using TCP communication according to the present disclosure allows a server to hash specific information to be stored, encrypt the hash value using unique information (key) of the server, store the encrypted information in a SEQ field and an ACK field in a header of a TCP packet, and transmit it to a client, and in this instance, the server changes the unique information every preset time to prevent an external attacker from decrypting the unique information even when attacked, thereby providing an effect of keeping the unique information from being exposed outside or being predicted.

Moreover, the method and system for storing information using TCP communication according to the present disclosure discourages a server from allocating a storage space before a client which desires to communicate is not determined to have spoofed Internet Protocol (IP) information, thereby providing an effect of effectively blocking various spoofing attacks on IP information by clients.

Also, the method and system for storing information using TCP communication according to the present disclosure records in a header section of a TCP packet having a standard format rather than a data section of the TCP packet using various formats based on programs, thereby providing an effect of facilitating application without modifications or changes at a client part used for conventional TCP communication.

### DESCRIPTION OF DRAWINGS

FIG. 1 is a flowchart illustrating a basic connection process of transmission control protocol (TCP) communication between a server and a client.

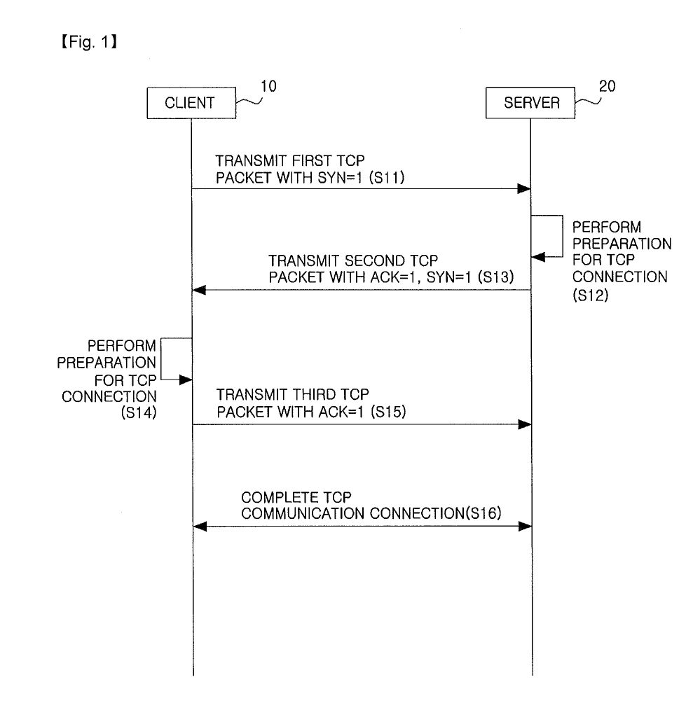

FIG. 2 is a flowchart illustrating a TCP 3-way handshake process performed in a TCP communication connection between a server and a client.

FIG. 3 is a flowchart illustrating a method for storing information using TCP communication according to an exemplary embodiment of the present disclosure.

### BEST MODE

Hereinafter, the present disclosure will be described in sufficient detail with reference to preferred embodiments and accompanying drawings for those having ordinary skill in the art to which the present disclosure belongs to easily practice the present disclosure. However, the present disclosure may be implemented in different forms and is not limited to the embodiments described herein.

A transmission control protocol (TCP) communication connection between a server and a client used in the present disclosure first performs a TCP 3-way handshake process using a TCP header, for mutual authentication.

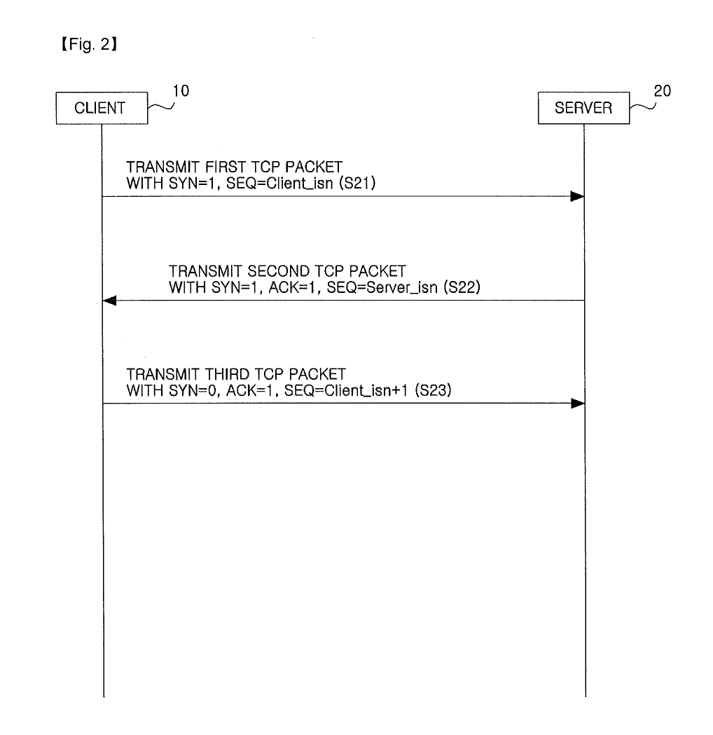

Hereinafter, a TCP 3-way handshake process performed in a TCP communication connection between a server and a client is described with reference to FIG. 2.

FIG. 2 is a flowchart illustrating a TCP 3-way handshake process performed in a TCP communication connection between a server and a client.

As shown in FIG. 2, the TCP 3-way handshake process first allows a client 10 to generate a random number, and the client 10 transmits, to a server 20, a TCP packet containing a header with a flag of a SYN field set to 1, i.e., active, and a SEQ field in which the generated random number is included (S21).

Then, in response to the received TCP packet, the server 20 generates a random number, and transmits, to the client 10, a TCP packet containing a header with a flag of a SYN field set to 1, i.e., active, an SEQ field in which the generated random number is stored, and an ACK field in which a value obtained by adding 1 to the random number stored in the SEQ field in the header of the TCP packet received from the client is included (S22).

Subsequently, the client 10 transmits, to the server 20, a TCP packet containing a header with a flag of a SYN field set to 0, i.e., inactive, a flag of an ACK field set to 1, i.e., active, a SEQ field in which a value obtained by adding 1 to the random number generated previously by the client 10 is included, and the ACK field to which a value obtained by adding 1 to the random number included in the SEQ field in the header of the TCP packet received from the server 20 is transmitted (S23).

In the TCP 3-way handshake process, if the client 10 spoofs an Internet Protocol (IP) address of the client 10 and transmits, to the server 20, a TCP packet containing a header with a flag of a SYN field set to 1 and a SEQ field in which a randomly generated number is included, the server 20 transmits the corresponding TCP packet to a location falsified by the client 10. As a result, the client 10 does not receive the corresponding TCP packet form the server 20, and thus, fails to identify the random number included in the corresponding TCP packet and authenticate the client 10.

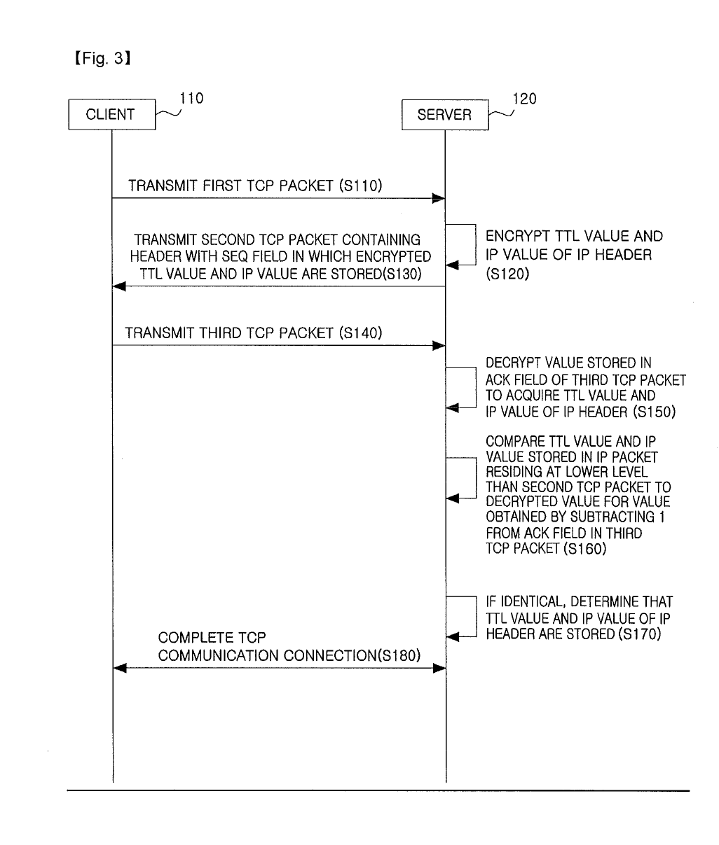

Hereinafter, a method for storing information using TCP communication according to the present disclosure is described in detail with reference to FIG. 3.

FIG. 3 is a flowchart illustrating a method for storing information using TCP communication according to an exemplary embodiment of the present disclosure.

As shown in FIG. 3, according to the method for storing information using TCP communication of the present disclosure, to request a TCP communication connection with a server 120, a client 110 transmits, to the server 120, a first TCP packet containing a header with a flag of a SYN field set to 1, i.e., active, and a SEQ field in which a random number generated by the client 110 is stored (S110).

In response to the first TCP packet received from the client 110, the server 120 encrypts at least one piece of information to be stored in the TCP packet (S120).

In addition to the method of encrypting at least one piece of information to be stored within the TCP packet, the server 120 may hash and encrypt the information, or may encrypt the information by executing a Hash-based Message Authentication Code (HMAC) having unique information of the server 120, that is, a key value. Particularly, it is obvious that not only the above-mentioned methods but also various encryption methods being currently used may be used as the encryption method.

The server 120 may encrypt information including a Time To Live (TTL) value and an IP value contained in an IP header paired with a TCP header among information needed to encrypt the information such as a packet reception time and a window size, and particularly, the server 120 preferably hashes the TTL value and the IP value and encrypts the hash value using unique information of the server 120. Particularly, in this instance, the server 120 may change the unique information every preset time to protect the information to be stored from hacking by an external attacker without exposing the information to hacking risks.

After the server 120 encrypts the specific information to be stored in the network packet including the TTL value and the IP value as described in the foregoing, the server 120 transmits, to the client 110, a second TCP packet containing a header with a flag of a SYN field and a flag of an ACK field each set to 1, i.e., active, a SEQ field in which the encrypted information is stored, and an ACK field in which a value obtained by adding 1 to the random number included in the SEQ field of the first TCP packet is stored (S130). In this instance, the SYN field of the second TCP packet having the flag in a state of 1 implies that the server 120 wishes to establish a communication connection with the client 110. Also, the SEQ field of the second TCP packet stores the encrypted information through the previous step S120 in 4 bytes in size.

Then, the client 110 transmits, to the server 120, a third TCP packet containing a header with a SYN field set to be active, a SEQ field in which a value obtained by adding 1 to the random number stored in the SEQ field in the header of the first TCP packet is stored, and an ACK field in which a value obtained by adding 1 to the encrypted information is included (S140).

After the server 120 receives the third TCP packet, the server 120 subtracts 1 from an ACK number among values stored in the ACK field of the third TCP packet, decrypts a resulting value, and acquires the specific information to be stored including the TTL value and the IP value contained in the hash value using unique information of the server 120 (S150).

Besides, the server 120 may identify the specific information by hashing the specific information stored in the ACK field of the third TCP packet again.

Subsequently, the server 120 compares information stored in an IP packet residing at a lower level than the second TCP packet to the decrypted value for the value obtained by subtracting 1 from the ACK field in the header of the third TCP packet (S160), and if they are identical, determines that the information is stored in the SEQ field of the second TCP packet and the ACK field of the third TCP packet (S170).

Accordingly, a TCP communication connection between the server 120 and the client 110 is established through transmission and reception of the TCP packet between the server 120 and the client 110 (S180).

As described in the foregoing, in the process of establishing a connection for TCP communication between the server 120 and the client 110, an expected effect is that the server 120 may easily store specific information to be stored in a header of a TCP packet being transmitted and received even though a separate storage space is not used.

Particularly, due to recording in a header section of a TCP packet having a standard format rather than a content section of the TCP packet using various formats based on programs, there is an effect of facilitating application without modifications or changes at a client part used for conventional TCP communication.

Also, the method for storing information using TCP communication may be stored in a computer-readable recording medium recording a program to be executed by a computer. In this instance, the computer-readable recording medium includes all types of recording devices to store data that can be read by a computer system. Examples of a computer-readable recording device include read-only memory (ROM), random access memory (RAM), compact disc read-only memory (CD-ROM), digital versatile disc (DVD)-ROM, DVD-RAM, magnetic tape, floppy disks, hard disks, optical storage devices, and the like. Also, the computer-readable recording medium can be distributed over network-coupled computer systems so that the computer-readable code is stored and executed in a distributed fashion.

A system for storing information using TCP communication according to another exemplary embodiment of the present disclosure is basically implemented in an environment in which the client 110 and the server 120 are interconnected.

In this instance, to request a TCP communication connection with the server, the client 110 transmits, to the server 120, a first TCP packet containing a header with a SYN field set to 1, i.e., active, and a SEQ field in which a random number generated by the client 110 is included, and transmits, to the server 120, a third TCP packet containing a header with an ACK field set to be active, a SEQ field in which a value obtained by adding 1 to the random number stored in the SEQ field in the header of the first TCP packet is stored, and the ACK field in which a value obtained by adding 1 to the encrypted information is included.

The server 120 receives, from the client 110, the first TCP packet containing the header with the SYN field set to 1, i.e., active and the SEQ field in which the random number generated by the client 110 is included, encrypts at least one piece of information to be stored in the header of the TCP packet, transmits, to the client 110, a second TCP packet containing a header with a SYN field and an ACK field each set to 1, i.e., active, a SEQ field in which the encrypted information is stored, and the ACK field in which a value obtained by adding 1 to the random number included in the SEQ field of the first TCP packet is stored, receives, from the client 110, a third TCP packet containing a header with an ACK field set to 1, i.e., active, a SEQ field in which a value obtained by adding 1 to the random number stored in the SEQ field of the header of the first TCP packet is stored, and the ACK field in which a value obtained by adding 1 to the encrypted information is stored, decrypts the ACK field in the header of the third TCP packet, compares it to a value obtained by decrypting a result of subtracting 1 from the ACK field in the header of the third TCP packet, and if they are identical, determines that the information is stored in the SEQ field of the second TCP packet and the ACK field of the third TCP packet.

The server 120 encrypts information including a TTL value and an IP value contained in an IP header paired with the TCP header used for TCP communication, and preferably, hashes the TTL value and the IP value, or encrypts the hash value using unique information of the server 120. Also, the server 120 changes the unique information every preset time. Particularly, when the server 120 detects an attack by an external attacker, the server 120 changes the unique information more frequently than that of a general case, that is, varies a unique information change time based on situations, so an effect of keeping the specific information to be stored from being exposed outside by an external attacker is expected.

The method and system for storing information using TCP communication according to the present disclosure allows, in a TCP communication connection between a server and a client, the server to store specific information to be stored in a SEQ field and an ACK field in a header of a TCP packet transmitted and received between the server and the client, thereby providing an effect of easily storing the specific information without using a separate storage space.

Also, the method and system for storing information using TCP communication according to the present disclosure allows a server to store specific information to be stored in a SEQ field and an ACK field in a header of a TCP packet transmitted to and received from a client for a TCP communication connection rather than a separate storage space, thereby providing an effect of reducing a load on the server.

Furthermore, the method and system for storing information using TCP communication according to the present disclosure allows a server to hash specific information to be stored, encrypt the hash value using unique information (key) of the server, store the encrypted information in a SEQ field and an ACK field in a header of a TCP packet, and transmit it to a client, and in this instance, the server changes the unique information every preset time to prevent an external attacker from decrypting the unique information even when attacked, thereby providing an effect of keeping the unique information from being exposed outside or being predicted.

Moreover, the method and system for storing information using TCP communication according to the present disclosure discourages a server from allocating a storage space before a client which desires to communicate is not determined to have spoofed IP information, thereby providing an effect of effectively blocking various spoofing attacks on IP information by clients.

Also, the method and system for storing information using TCP communication according to the present disclosure records in a header section of a TCP packet having a standard format rather than a data section of the TCP packet using various formats based on programs, thereby providing an effect of facilitating application without modifications or changes at a client part used for conventional TCP communication.

While the preferred embodiments of the present disclosure have been described, the present disclosure is not limited thereto and it is obvious that many changes and modifications may be made within the spirit and scope of the present disclosure, and such embodiments fall within the appended claims.

1. A method for storing information using transmission control protocol (TCP) communication, the method comprising:
a communication connection request operation of transmitting, by a client, to a server a first TCP packet containing a header with a SYN field set to be active and an SEQ field in which a random number generated by the client is included, to request a TCP communication connection with the server;
an encryption operation of encrypting, by the server, at least one piece of information to be stored in the first TCP packet;
a communication connection confirmation operation of transmitting, by the server, to the client a second TCP packet containing a header with a SYN field set to be active, a SEQ field in which the encrypted information is stored, and an ACK field in which a value obtained by adding 1 to the random number included in the SEQ field of the first TCP packet is stored;
a response operation of transmitting, by the client, to the server a third TCP packet containing a header with an ACK field set to be active, a SEQ field in which a value obtained by adding 1 to the random number stored in the SEQ field in the header of the first TCP packet is stored, and the ACK field in which a value obtained by adding 1 to the encrypted information is included;
a decryption operation of decrypting, by the server, the ACK field in the header of the third TCP packet to acquire the encrypted information; and
a determination operation of comparing, by the server, information stored in an IP packet residing at a lower level than the second TCP packet to a value obtained by decrypting a result of subtracting 1 from the ACK field in the header of the third TCP packet, and if they are identical, determining that the information is stored in the SEQ field of the second TCP packet and the ACK field of the third TCP packet.

2. The method for storing information using TCP communication according to claim 1, wherein the encryption operation comprises encrypting information including a Time To Live (TTL) value and an Internet Protocol (IP) value contained in an IP header paired with a TCP header used for TCP communication.

3. The method for storing information using TCP communication according to claim 2, wherein the encryption operation comprises:
hashing, by the server, the TTL value and the IP value, and encrypting the hash value using unique information of the server.

4. The method for storing information using TCP communication according to claim 3, wherein the encryption operation comprises changing, by the server, the unique information every preset time.

5. A computer-readable recording medium having a program recorded therein for causing a computer to perform the method according to claim 1.

6. A system for storing information using transmission control protocol (TCP) communication that performs TCP communication between a server and a client, the system comprising:
the server to receive, from the client, a first TCP packet containing a header with a SYN field set to be active and an SEQ field in which a random number generated by the client is included, to encrypt at least one piece of information to be stored in the TOP packet, and to transmit, to the client, a second TCP packet containing a header with a SYN field and an ACK field set to be active, a SEQ field in which the encrypted information is stored, and the ACK field in which a value obtained by adding 1 to the random number included in the SEQ field of the first TCP packet is stored,
to receive, from the client, a third TCP packet containing a header with an ACK field set to be active, a SEQ field in which a value obtained by adding 1 to the random number stored in the SEQ field in the header of the first TCP packet is stored, and the ACK field in which a value obtained by adding 1 to the encrypted information is stored,
to decrypt the ACK field in the header of the third TCP packet to acquire the encrypted information, to compare information stored in an IP packet residing at a lower level than the second TCP packet to a value obtained by decrypting a result of subtracting 1 from the ACK field in the header of the third TCP packet, and if they are identical, to determine that the information is stored in the SEQ field of the second TCP packet and the ACK field of the third TCP packet.

7. The system for storing information using TCP communication according to claim 6, wherein the server encrypts information including a Time To Live (TTL) value and an Internet Protocol (IP) value contained in an IP header paired with a TCP header used for TCP communication.

8. The system for storing information using TCP communication according to claim 7, wherein the server hashes the TTL value and the IP value, and encrypts the hash value using unique information of the server.

9. The system for storing information using TCP communication according to claim 8, wherein the server changes the unique information every preset time.
